(19) United States
(12) Patent Application Publication
(10) Pub. No.: US 2009/0017746 A1
(43) Pub. Date: Jan. 15, 2009

(54) Apparatus having a heated screen for melting ice, snow or the like

(76) Inventors: Daniel Clemenz, Waukegan, IL (US); Gary R. Apfelbaum, Antioch, IL (US)

Correspondence Address: LAMPEL & ASSOCIATES, P.C., 555 SKOKIE BLVD., SUITE 500, NORTHBROOK, IL, 60062, US

(21) Appl. No.: 11/827,437

(22) Filed: Jul. 12, 2007

(51) Int. Cl. H05B 1/00; F24F 9/00

(52) U.S. Cl. 454/188; 219/213

(57) ABSTRACT

The present invention generally relates to an apparatus for preventing the accumulation of snow, ice, frost, hail or the like from obstructing the flow of primary air, air or the exhaust of sewer gas into or out of a building. The apparatus is also suitable to prevent leaves, animals or other debris from becoming trapped within the air flow pipes of the building. The apparatus has a screen which may be electrically connected to a heating device. The apparatus may further be attached to a thermostat to automatically turn the heating device on or off at preset temperatures. The apparatus may be incorporated into new pipes or may be attached onto existing pipes.

### BACKGROUND OF THE INVENTION

The present invention generally relates to an apparatus for preventing the accumulation of snow, ice, frost, hail or the like from obstructing the flow of primary air, air or the exhaust of sewer gas into or out of a building. The apparatus is also suitable to prevent leaves, animals or other debris from becoming trapped within the air flow pipes of the building and/or appliances of the building. The apparatus has a screen which may be electrically connected to a heating device. The apparatus may further be attached to a thermostat to automatically turn the heating device on or off at preset temperatures. The apparatus may be incorporated into new pipes or may be attached onto existing pipes.

Many homes, commercial buildings and industrial buildings have pipes which have an exposed opening outside. Typically, these pipes are used to allow the flow of air into or out of the building. Many of these pipes allow the flow of air inward toward a furnace for heating the air and then circulating the air within the building. The problem with many of these pipes is that objects often become trapped within the pipe and prevent the flow of air into or out of the building. Some of these objects include, leaves, animals and garbage. Further, a major problem with objects obstructing the flow of air through the pipe is the accumulation of ice, snow, frost, hail or the like within the pipe during cold weather. Some attempts to solve similar problems have been made.

U.S. Pat. No. 7,127,867 to Smeja et al. discloses a method of making a metal snow guard. The snow guard has a solid layer of soldering material on its base to be heated and melted with application of heat to the upper side of the snow guard to solder the base to an underlying metal roof. The soldering material may be applied as spaced spots or projections providing a rough surface on the underside of the snow guard. The amount of solder and/or flux in the solid layer is limited so that the solder and/or flux does not flow outwardly from the snow guard and run down the metal roof thereby damaging or marring the metal roof surface. The snow guards may be formed of a few pieces of sheet metal. The projections of soldering material may be formed by forcing a paste of solder and flux through spaced holes in a plate or screen onto the base.

U.S. Pat. No. 5,901,507 to Smeja et al. discloses a snow guard for restraining ice and snow along the roofs of buildings. The snow guard is of plastic material having a flat base plate with an upstanding snow retention plate upwardly therefrom and laterally across the base. A reinforcing plate extends upwardly from the base plate, as well, serving to reinforce the retention plate. With the reinforcing plate intersecting and abutting the retention plate at a central axis portion of the base plate.

However, these snow guards fail to prevent the accumulation of snow, ice, frost, hail or the like in the manner described by the present invention. A need, therefore, exists for an improved apparatus which provides an easy and effective manner for preventing snow, ice, frost, hail or the like from obstructing the flow of air into or out of a building. Further, a need exists for an improved apparatus which prevents the accumulation of leaves, animals, debris or the like from decreasing the air flow of a pipe into a building. In addition, a need exists for an improved apparatus which also may prevent carbon monoxide and/or other dangerous gases from accumulating within a building as a result of restricted airflow out of the building.

### SUMMARY OF THE INVENTION

The present invention generally relates to an apparatus for preventing the accumulation of snow, ice, frost, hail or the like from obstructing the flow of primary air, air or the exhaust of sewer gas into or out of a building. The apparatus is also suitable to prevent leaves, animals or other debris from becoming trapped within the air flow pipes of the building. The apparatus has a screen which may be electrically connected to a heating device. The apparatus may further be attached to a thermostat to automatically turn the heating device on or off at preset temperatures. The apparatus may be incorporated into new pipes or may be attached onto existing pipes.

An advantage of the present invention is to provide an apparatus to prevent the accumulation of snow, ice, frost, hail or the like from obstructing the flow of air into or out of a building.

A further advantage of the present invention is to provide an apparatus which prevents leaves, animals or other debris from becoming trapped within an air flow pipe of a building.

Another advantage of the present invention is to provide an apparatus which increases the air flow into or out of a building which may be easily attached to an existing pipe.

A further advantage of the present invention is to provide an apparatus which increases the air flow into or out of a building which may be easily cleaned.

Yet another advantage of the present invention is to provide an apparatus which has holes for allowing melted snow, ice, frost or the like to exit the air flow pipe of a building.

In an embodiment, the apparatus for increasing the flow of air through a pipe has: a generally cylindrical tube having a first end and a second end and a generally hollow interior; a screen located within the generally hollow interior wherein air passing from the first end to the second end passes through the screen; a heating device electrically connected to the screen wherein the heating device obtains a temperature hot enough to melt ice and snow; and an electrical cable connecting the heating device to a power source.

In an embodiment, the apparatus has a thermostat electrically connected to the heating device wherein the thermostat regulates the heating device.

And in an embodiment, the apparatus has a plurality of ridges within the generally hollow interior wherein the screen rests within a groove created by the plurality of ridges.

In another embodiment, the apparatus has a plurality of openings along a circumference of the generally cylindrical tube wherein water accumulated within the generally hollow interior may exit the generally cylindrical tube through the plurality of openings.

In another embodiment, the apparatus has a series of louvers near the screen wherein the louvers direct the flow of air within the generally hollow interior.

For a more complete understanding of the above listed features and advantages of the heated screen for melting ice, snow, frost hail or the like, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a side plan view of the apparatus of the present invention.

FIG. 2 illustrates a top plan view of the screen of the present invention.

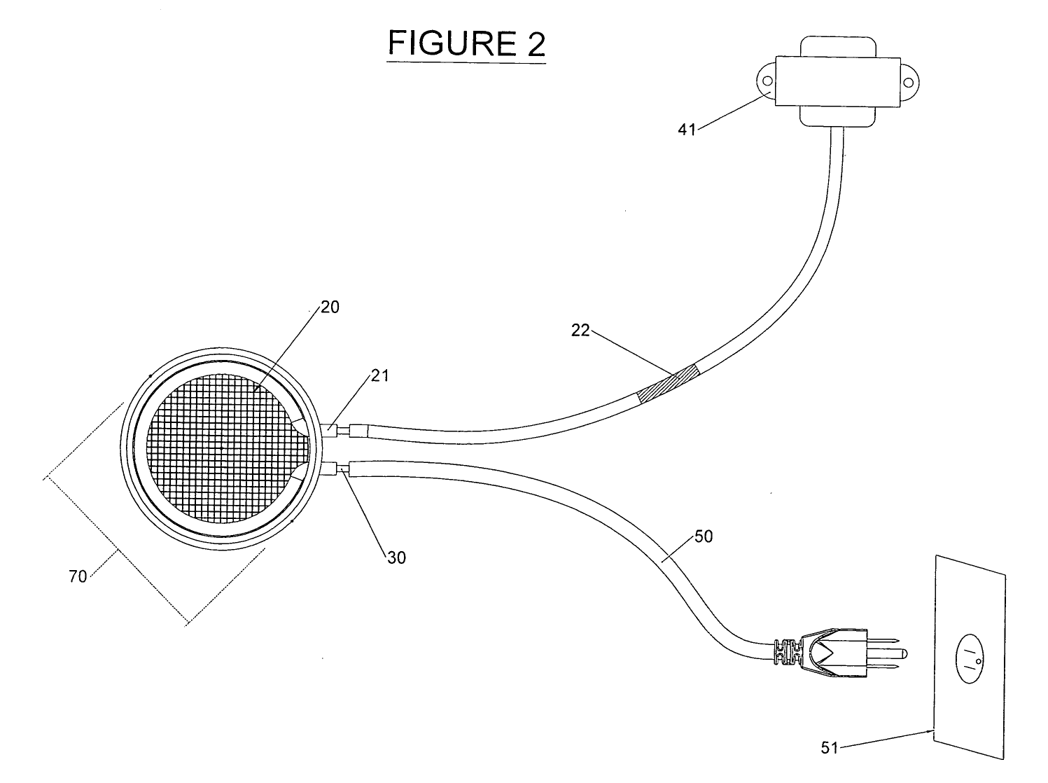

FIG. 3 illustrates a top plan view of the present invention wherein a louver is implemented.

FIG. 4 illustrates an image of the connection of the present invention to the furnace of a building.

FIG. 5 illustrates a side view of the apparatus wherein the screen is secured within a groove created by two ridges.

FIG. 6 illustrates a top perspective view of an embodiment of the present invention.

### DETAILED DESCRIPTION OF THE PREFERRED EMBODIMENTS

The present invention generally relates to an apparatus for preventing the accumulation of snow, ice, frost, hail or the like from obstructing the flow of primary air, air or the exhaust of sewer gas into or out of a building. The apparatus is also suitable to prevent leaves, animals or other debris from becoming trapped within the air flow pipes of the building. The apparatus has a screen which may be electrically connected to a heating device. The apparatus may further be attached to a thermostat to automatically turn the heating device on or off at preset temperatures. The apparatus may be incorporated into new pipes or may be attached onto existing pipes.

Many of the pipes currently used in homes have screens to prevent debris and/or animals from entering the home. However, there exists no known screen which heats up so as to melt any ice or snow which may build up and block or restrict the flow of air through the pipe. As a result, it is common for the pipes to be largely or completely blocked and, therefore, for the furnace not to work or to work at a lower output. Further, if the pipes become blocked, it is possible for carbon monoxide and/or other dangerous gasses to accumulate, requiring the user to have a service technician clear the pipes.

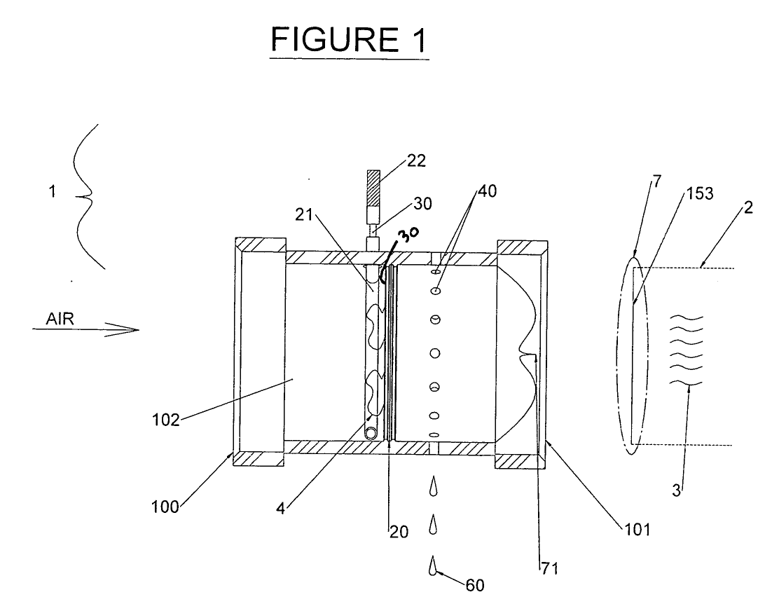

Referring now to the drawings wherein like numerals refer to like parts, FIG. 1 generally illustrates an apparatus 1 of the present invention which is used in conjunction with a pipe 2. The apparatus 1 is particularly suitable to, for example, melt ice, snow, sleet, frost or the like from constricting the air flow of the pipe 2. As a result, air 3 may pass through the pipe 2 more easily.

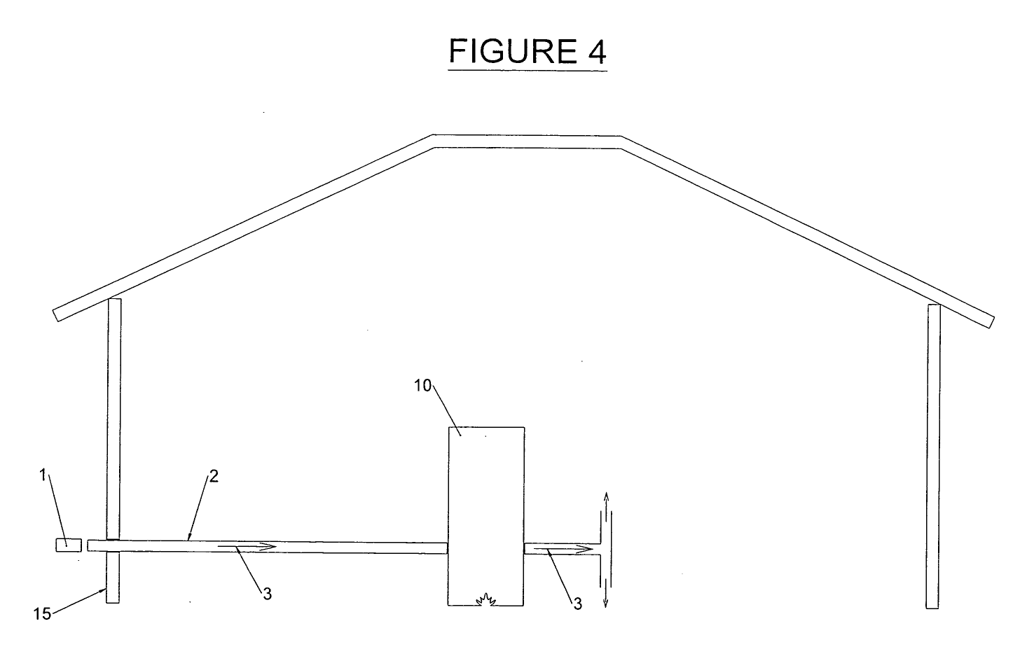

Most homes have a pipe 2 which connects, for example, a furnace 10 or stove 11 (FIG. 4), to an exterior 15 of the home. Some of these pipes 2 may be concentric pipes 2 allowing the flow of air in two different directions. It should be noted that the present invention may be used on these concentric pipes as well as single flow pipes 2. The pipes 2 are typically made from PVC, metal or other similar suitable material. The purpose of the pipe 2 is to allow the flow of air 3 into or out of the home. More specifically, air 3 may be pulled into the home and brought into the furnace 10 where it is mixed with natural gas or an alternative fuel and heated and then moved throughout the home. It is common for these pipes 2 to become clogged by, for example, leaves, animals or ice, snow or the like. As a result, the air 3 cannot pass through the pipe 2 and reach the, for example, furnace 10. In addition, the apparatus of the present invention may be used on sewer vent pipes or other pipes (as opposed to furnace pipes) which may vent into an attic or through a roof of a building.

The apparatus 1 may have a first end 100 and a second end 101. The apparatus 1 may be generally in the shape of a cylinder having a hollow interior 102. Within the hollow interior 102 of the cylinder may be a screen 20. The screen 20 may be directly molded into the apparatus 1 during the construction of the apparatus. Alternatively, the screen 20 may be added to the apparatus 1 (or pipe 2) after the pipe 2 is constructed.

The screen 20 may be generally circular and may have a diameter 70 which is slightly smaller than a diameter 71 of the apparatus 1. More specifically, the screen 20 may extend to cover an entire planar surface within the hollow interior 102 of the apparatus 1 so that any air 3 which passes from the first end 100 of the apparatus 1 to the second end 101 of the apparatus 1 must pass through one of the plurality of openings in the screen 20. In an embodiment, the second end 101 of the apparatus 1 may be secured to an existing end 7 of the pipe 2 of, for example, the home. More specifically, the second end 101 of the apparatus 1 may be secured to the existing pipe 2 by, for example, glue, screws, magnets or the like.

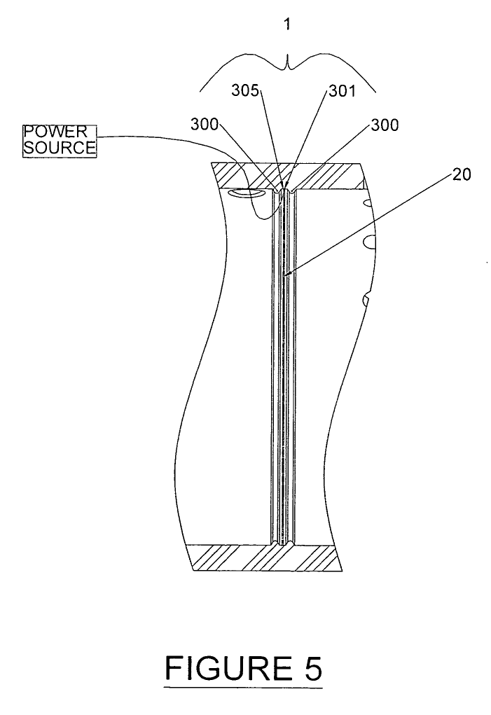

Referring now to FIG. 5, within the hollow interior 102 of the apparatus 1 may be two ridges 300. The ridges 300 may be formed as two slightly raised gaskets forming a narrow grove 305 in which the screen 20 may rest in. More specifically, an edge 301 of the screen 20 may rest within the two ridges 300 and secured there by, for example, friction.

The apparatus 1 may be designed to fit on an existing pipe 2. Alternatively, the apparatus 1 may be inserted into the pipe 2 during the production process of the pipe 2. If the apparatus 1 is designed to fit an existing pipe 2 the apparatus 1, the apparatus 1 may, for example, be attached to an end 7 of the pipe 2. In such a case, the apparatus 1 may be inserted within or around the end 7 of a pipe 2. Further, if the apparatus 1 is inserted over the end of an existing pipe 2, the apparatus 1 may be easily removed for cleaning and maintenance of the screen 20. If the apparatus 1 is designed to be fitted on an existing pipe 2, the diameter 71 of the second end 101 of the apparatus 1 may be slightly larger than a diameter 153 of the pipe 2. While the apparatus 1 is secured onto the pipe 2, an air and/or water tight sealed may be formed. Further, glue or another substance may be used to create a water-tight seal between the pipe 2 and the apparatus 1.

The apparatus 1 may have, for example, a screen 20, a heating element 21, and a thermostat 22. The heating element 21 may be, for example, embedded into the pipe 2 or may be otherwise attached to the screen 20 so as to allow the individual wires of the screen 20 to heat up. A heat conducting wire 30 may connect the heating element 21 to the screen 20. When the thermostat 22 registers a temperature below a specific preset limit, the heating element 21 may be activated, thereby heating the screen 20. The thermostat 22 may be set to be activated for a predetermined amount of time before being automatically turned off. In an embodiment, the heating element 21 may be manually activated. When the screen 20 is heated by the heating element 21 ice, snow, frost or the like may be melted and the flow of air 3 through the pipe 2 may be restored.

The thermostat 22 works by regulating the temperature of a system so that the system's temperature is maintained near a desired setpoint temperature. There are numerous of different types of thermostats 22, including bi-metal, wax pellet and mechanical, any of which may be used in connection with the present apparatus 1.

In an embodiment, a plurality of holes 40 may be located adjacent to the screen 20 so as to allow water 60, which may be created from the melting snow or ice 4, to exit the pipe 2 without draining into the home. As a result, water 60 created from the melting of the ice 4, snow or the like is less likely to flow into the home and cause any damage to the furnace 10 or other object. Further, the plurality of holes 40 may allow water 60 to exit the apparatus thereby reducing the possibility of corrosion of the screen 20 and or other elements of the apparatus.

In addition to melting ice, snow, frost or the like, the screen 20 may prevent leaves, animals or other obstructions from passing through the pipe 2 and obstructing the air 3 flow through the pipe 2. As a result, a person may easily remove the debris from the screen 20 thereby restoring air 3 flow.

The heating element 21 may be attached to a transformer 41 that is connected to, for example, a home, industrial or commercial voltage supply. The amount of voltage supplied by the transformer 41 may be stepped down from the total voltage of the building so as to increase the safe operation of the apparatus 1. A power chord 50 may attach the heating element 21 to an outlet 51. Preferably, the power chord 50 should be weather proof and resistant to extreme temperatures. In the preferred embodiment, the power chord 50 remains inside the building, however, the power chord 50 may be located outside the building.

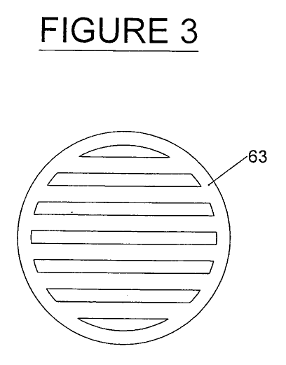

Referring now to FIG. 3, the apparatus 1 may have, for example, a plurality of louvers 63 which may further prevent ice, snow or other obstacles from obstructing the flow of air 3 through the pipe 2. The louvers 63 may be implemented instead of, or in addition to, the screen 20. In such an embodiment, the louvers 63 may be connected to the heating element 21 and may be heated instead of the screen 20 to melt the ice 4, snow or the like. In an embodiment, the heating element 21 may not only heat the screen 20, but may also heat a portion of the actual pipe 2. As a result, ice 4, snow or the like may be more easily melted and the flow of air 3 restored more quickly.

In an embodiment, the screen 20 of the apparatus is not connected to a heating device, but actually acts as the actual heating device. More specifically, the cross-wires which form the screen 20 are heated up directly from a power source, as opposed to the screen 20 being in contact with a separate heating device.

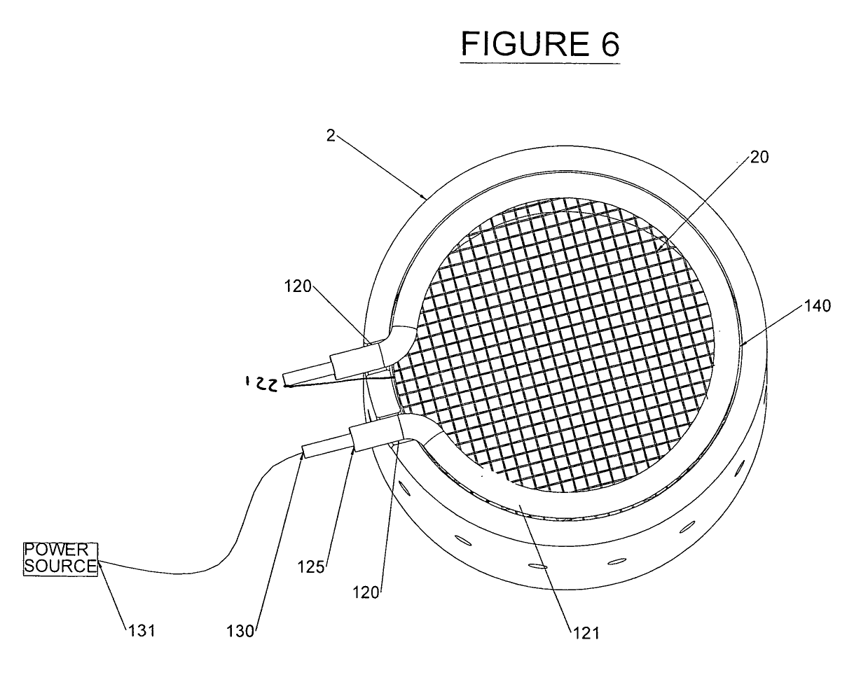

Referring now to FIG. 6, the apparatus may have a plurality of openings 120 on the side of the pipe 2. The plurality of openings 120 may allow a metal wire 121 to enter, be wrapped around an inner wall 122 of the hollow interior 102 and then exit the hollow interior 121. The metal wire 121 may have a hollow interior 125 in which a wire 130 may be inserted. The wire 130 may be connected to a power source 131 which may heat the wire 130. The heat may then be transferred to the metal wire 121 which is in contact with the screen 20. As a result, the screen 20 of the apparatus may be heated. The metal wire 121 may be secured within the hollow interior 102 of the pipe 2 by, for example, being wedged between the screen 20 and a securing ring 140.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

We claim:

1) An apparatus for increasing air flow through a pipe comprising:
a generally cylindrical tube having a first end and a second end and a generally hollow interior;
a screen located within the generally hollow interior wherein air passing from the first end to the second end passes through the screen;
a heating device electrically connected to the screen wherein the heating device obtains a temperature hot enough to melt ice and snow; and
an electrical cable connecting the heating device to a power source.

2) The apparatus of claim 1 further comprising;
a thermostat electrically connected to the heating device wherein the thermostat regulates the heating device.

3) The apparatus of claim 1 further comprising:
a plurality of ridges within the generally hollow interior wherein the screen rests within a groove created by the plurality of ridges.

4) The apparatus of claim 1 further comprising:
an opening along a circumference of the generally cylindrical tube wherein water accumulated within the generally hollow interior may exit the generally cylindrical tube through the plurality of openings.

5) The apparatus of claim 1 further comprising;
a series of louvers near the screen wherein the louvers direct the flow of air within the generally hollow interior.

6) An apparatus for increasing air flow through a pipe comprising:
a generally cylindrical tube having a first end and a second end and a generally hollow interior;
a screen located within the generally hollow interior wherein air passing from the first end to the second end passes through the screen and wherein the screen acts as a heating device and wherein the screen is electrically connected to a power source.

7) An apparatus for increasing air flow through a pipe comprising:
a generally cylindrical tube having a first end and a second end and a generally hollow interior;
a screen located within the generally hollow interior wherein air passing from the first end to the second end passes through the screen;
a metal wire located within the generally hollow interior wherein the metal wire is in contact with an interior wall of the cylindrical tube;
a heating device electrically connected to the metal wire wherein the heating device transfers heat to the metal wire and wherein the metal wire obtains a temperature hot enough to melt ice and snow; and
an electrical cable connecting the heating device to a power source.
